(19) United States
(12) Patent Application Publication
(10) Pub. No.: US 2009/0134364 A1
(43) Pub. Date: May 28, 2009

(54) Polyamide acid containing ultrafine metal particle

(76) Inventors: Hidemi Nawafune, Hyogo (JP); Kensuke Akamatsu, Hyogo (JP)

Correspondence Address: KRATZ, QUINTOS & HANSON, LLP, 1420 K Street, N.W., Suite 400, WASHINGTON, DC, 20005, US

(21) Appl. No.: 11/991,161

(22) PCT Filed: Aug. 28, 2006
(86) PCT No.: PCT/JP2006/316846

§ 371 Date: Apr. 22, 2008

(30) Foreign Application Priority Data
Sep. 2, 2005 (JP) 2005-255341

(51) Int. Cl. H01B 1/22

(52) U.S. Cl. 252/513; 252/512; 252/514

(57) ABSTRACT

The present invention provides a method for producing a polyamic acid containing ultrafine metal particles, which contains the steps of contacting an aqueous solution containing a water-soluble metal compound with fine polyamic acid particles to adsorb metal ions to the fine polyamic acid particles, and then performing a reduction treatment; and a conductive adhesive which contains as an active ingredient the polyamic acid containing ultrafine metal particles. The conductive adhesive of the present invention has excellent performance which enables the adhesive to be used as an alternative to high-temperature lead solders.

### TECHNICAL FIELD

The present invention relates to a polyamic acid containing ultrafine metal particles, a production method therefor, and a conductive adhesive.

### BACKGROUND ART

Tin-lead solders have been used to join electronic parts for many years. However, when electrical devices, automobiles, etc. that have solder joints are disposed, solder components are leached by rain water (in particular, acid rain) and pollute soil, groundwater, etc. with lead, thereby causing a serious problem with the influence on the human body. It was thus decided that the use of solders containing lead would be restricted from 2006.

Tin-silver-based, tin-bismuth-based, tin-zinc-based, and like solders can be used as alternatives to tin-lead-based eutectic solders, but no alternative technology to high-temperature lead solders with a high lead content has yet been developed. The use of a high-temperature lead solder, although not restricted at present, is expected to be subject to restrictions in future, and therefore the development of an alternative technology to high-temperature lead solders has become an urgent necessity.

A joining technology using a conductive adhesive is known as an alternative to high-temperature lead solder joining (see Non-Patent Documents 1 and 2 below). The conductive adhesives mainly used are those obtained by uniformly dispersing conductive fillers, such as carbon black, nickel, copper, silver powder, etc. in resin binders. Of such conductive adhesives, the international market scale of isotropic adhesives is about ¥10 billion, with U.S. manufacturers taking a 40% share of the market. The international market of anisotropic conductive adhesives and films is about ¥40 billion (and their domestic market is about ¥19.3 billion), and with the rapid growth of flat-panel display devices, an annual growth rate of about 20% is expected. Application of this technology to fine-pitch wiring, as well as its performance as an alternative to high-temperature lead solder joining, is also expected.
Non-Patent Document 1: Munenori YAMASHITA, Yasuo SHIRAI, Masaaki MORIMITSU, Katsuaki SUGANUMA; “Research on High-Temperature Reliability Using Ag—Sn-Alloy-Epoxy-Based Conductive Adhesive”, proceedings of the 13th symposium on microelectronics, pp. 372-375 (2003)
Non-Patent Document 2: Eiichi IDE, Shinji ANGATA, Akio HIROSE, Kojiro KOBAYASHI, “Joining Process Using Silver Nanoparticles—Influence of Joining Parameters”, proceedings of the 14th symposium on microelectronics, pp. 193-196 (2004)

### DISCLOSURE OF THE INVENTION

### Problems To Be Solved by the Invention

The present invention has been made in view of the above-mentioned situations of the prior art, and its main object is to provide a novel conductive adhesive with excellent performance that can be used as an alternative to high-temperature lead solders.

### Means for Solving the Problems

The present inventors conducted extensive research to achieve the above object. As a result, the present inventors found that when metal ions are adsorbed to fine polyamic acid particles, which are a precursor of a polyimide resin, and then reduced under specific conditions, a composite of the polyamic acid and metal nanoparticles can be obtained in which nano-sized ultrafine metal particles are uniformly dispersed in fine polyamic acid particles. The inventors further found that, in this composite, the metal component is present as nano-sized ultrafine particles and thus has a greatly lowered melting point, thereby making it possible to carry out joining at temperatures as low as about 200° C.; and at the same time, polyimidization of the polyamic acid proceeds under heating to form an insulating protective film of polyimide resin with excellent heat resistance, thereby ensuring the stability of the joined part at high temperatures and enabling highly reliable joining. The present invention has been accomplished based on these findings.

The present invention provides the polyamic acid containing ultrafine metal particles; production method therefor, and conductive adhesive, described below.

1. A polyamic acid containing ultrafine metal particles, the polyamic acid comprising ultrafine metal particles dispersed in fine polyamic acid particles.

2. The polyamic acid containing ultrafine metal particles according to Item 1, wherein the ultrafine metal particles are those of at least one member selected from the group consisting of Au, Pt, Pd, Ag, Cu, Sn, Ni, and Co.

3. A method for producing a polyamic acid containing ultrafine metal particles, the method comprising contacting an aqueous solution containing a water-soluble metal compound with fine polyamic acid particles to adsorb metal ions to the fine polyamic acid particles; and then performing a reduction treatment.

4. The method according to Item 3, wherein the water-soluble metal compound is a compound containing at least one metal component selected from the group consisting of Au, Pt, Pd, Ag, Cu, Sn, Ni, and Co.

5. The method according to Item 3 or 4, wherein the reduction treatment is performed by (i) contact with an aqueous solution containing a reducing agent, (ii) heating in a hydrogen stream, or (iii) ultraviolet irradiation.

6. A conductive adhesive comprising as an active ingredient a polyamic acid containing ultrafine metal particles according to Item 1 or 2.

The ultrafine metal particle-containing polyamic acid and its production method according to the present invention are described below in detail.

### (1) Method for Producing Polyamic Acid Containing Ultrafine Metal Particles

The ultrafine metal particle-containing polyamic acid of the present invention can be obtained by adsorbing metal ions to fine polyamic acid particles and then reducing the metal ions. The following is a specific description of the components used in the method and the production procedures.

### Fine Polyamic Acid Particles

The fine polyamic acid particles are not limited, and any of fine polyamic acid particles produced by various known methods can be used. The fine polyamic acid particles serve as a precursor of a polyimide resin, and may be a precursor of either a thermosetting polyimide resin or a thermoplastic polyimide resin. In particular, when using fine polyamic acid particles that serve as a precursor of a thermoplastic polyimide resin, the ultrafine metal particle-containing polyamic acid of the present invention, when used as a conductive adhesive, has good flowability, can be readily used as a conductive adhesive, and ensures sufficient joining strength at relatively low heating temperatures. Both fine polyamic acid particles that serve as a precursor of a thermosetting polyimide resin, and fine polyamic acid particles that serve as a precursor of a thermoplastic polyimide resin can be obtained under known conditions by suitably selecting the molecular weight of the fine polyamic acid particles and the types of monomers used.

Examples of known production methods for fine polyamic acid particles include (a) a method in which a polyamic acid varnish is prepared and added dropwise into a poor solvent to obtain particles by precipitation (Japanese Examined Patent Publication No. 1963-5997); (b) a method for producing fine polyamic acid particles by reacting (i) an aromatic tetracarboxylic dianhydride with (ii) an aromatic diamine in (iii) an organic solvent that dissolves (i) and (ii) but does not dissolve the polyamic acid formed, wherein the total amount of (i) and (ii) is 10 wt. % or less relative to (iii) (Japanese Unexamined Patent Publication No. 1997-302089); (c) a method for producing fine polyamic acid particles, comprising the first step of separately preparing a first solution containing a tetracarboxylic anhydride and a second solution containing a diamine compound, and the second step of mixing the first solution with the second solution to precipitate fine polyamic acid particles from the mixed solution (Japanese Unexamined Patent Publication No. 1999-140181). Any of the fine polyamic acid particles obtained by the above methods can be used in the present invention.

Among the above methods, for example, the method described in Japanese Unexamined Patent Publication No. 1999-140181 is preferable since the particle shape, particle size distribution, etc. can be easily controlled. This method is specifically described below.

In this method, a first solution containing a tetracarboxylic anhydride and a second solution containing a diamine compound are individually prepared in the first step. That is, the tetracarboxylic anhydride and diamine compound need to be prepared as separate solutions.

The tetracarboxylic anhydride used in the first solution is not limited, and, for example, tetracarboxylic anhydrides heretofore used for polyimide synthesis can be used. Usable examples include 3,3′,4,4′-benzophenonetetracarboxylic dianhydride (BTDA), 3,3′,4,4′-biphenyltetracarboxylic dianhydride, 2,3,3′,4′-biphenyltetracarboxylic dianhydride, pyromellitic dianhydride, 1,3-bis(2,3-dicarboxyphenoxy)benzene dianhydride, 1,4-bis(2,3-dicarboxyphenoxy)benzene dianhydride, 2,3,3′,4′-benzophenonetetracarboxylic dianhydride, 2,2′,3,3′-benzophenonetetracarboxylic dianhydride, 2,2′,3,3′-biphenyltetracarboxylic dianhydride, 2,2′,6,6′-biphenyltetracarboxylic dianhydride, naphthalene-1,2,4,5-tetracarboxylic dianhydride, anthracen-2,3,6,7-tetracarboxylic dianhydride, phenanthrene-1,8,9,10-tetracarboxylic dianhydride, 4,4′-oxydiphthalic anhydride (ODPA), and like aromatic Tetracarboxylic anhydrides; butane-1,2,3,4-tetracarboxylic dianhydride, and like aliphatic tetracarboxylic anhydrides; cyclobutane-1,2,3,4-tetracarboxylic dianhydride and like alicyclic tetracarboxylic anhydrides; thiophene-2,3,4,5-tetracarboxylic anhydride, pyridine-2,3,5,6-tetracarboxylic anhydride, and like heterocyclic tetracarboxylic anhydrides; etc. These can be used singly or in combination of two or more. In the present invention, BTDA, pyromellitic dianhydride, etc., are especially preferable.

Tetracarboxylic anhydrides that are partially substituted with acid chlorides can also be used. Substitution with acid chlorides has effects that the reaction rate can be increased and the diameter of the obtained particles can be decreased by selecting the substitution condition. Usable acid chlorides include, for example, diethyl pyromellitate diacyl chloride and the like.

The solvent used in the first solution is not limited as long as it substantially dissolves the tetracarboxylic anhydride and does not dissolve the polyamic acid formed. Examples of such solvents include 2-propanone, 3-pentanone, tetrahydropyrene, epichlorohydrin, acetone, methyl ethyl ketone (MEK), tetrahydrofuran (THF), ethyl acetate, acetanilide, methanol, ethanol, isopropanol, toluene, xylene, etc. At least one of these solvents can be used as the solvent for the first solution. Solvents that dissolve polyamic acids, for example, aprotic polar solvents such as N,N-dimethylformamide (DMF), N,N-dimethylacetamide (DMAc), N-methyl-2-pyrrolidone (NMP), etc., are also usable when they are mixed with poor solvents for polyamic acids, such as acetone, ethyl acetate, MEK, toluene, xylene, etc., and thereby adjusted so as to precipitate polyamic acids.

The tetracarboxylic anhydride concentration of the first solution can be suitably selected according to the type of the tetracarboxylic anhydride used, the concentration of the second solution, etc., and is usually about 0.001 to about 0.20 mol/l, and preferably about 0.01 to 0.10 mol/l.

The diamine compound used in the second solution is not limited, and, for example, diamine compounds heretofore used for polyimide synthesis can be used. Usable examples include 4,4′-diaminodiphenylmethane (DDM), 4,4′-diaminodiphenyl ether (DPE), 4,4′-bis(4-aminophenoxy)biphenyl (BAPB), 1,4′-bis(4-aminophenoxy)benzene (TPE-Q), 1,3′-bis(4-aminophenoxy)benzene (TPE-R), o-phenylenediamine, m-phenylenediamine, p-phenylenediamine, 3,4′-diaminodiphenyl ether, 4,4′-diaminodiphenyl sulfone, 3,4-diaminodiphenyl sulfone, 3,3′-diaminodiphenyl sulfone, 4,4′-methylene-bis(2-chloroaniline), 3,3′-dimethyl-4,4′-diaminobiphenyl, 4,4′-diaminodiphenyl sulfide, 2,6′-diaminotoluene, 2,4-diaminochlorobenzene, 1,2-diaminoanthraquinone, 1,4-diaminoanthraquinone, 3,3′-diaminobenzophenone, 3,4-diaminobenzophenone, 4,4′-diaminobenzophenone, 4,4′-diaminobibenzyl, R(+)-2,2′-diamino-1,1′-binaphthalene, S(+)-2,2′-diamino-1,1′-binaphthalene, and like aromatic diamines; 1,2-diaminomethane, 1,4-diaminobutane, tetramethylenediamine, 1,10-diaminododecane, and like aliphatic diamines; 1,4-diaminocyclohexane, 1,2-diaminocyclohexane, bis(4-aminocyclohexyl)methane, 4,4′-diaminodicyclohexylmethane, and like alicyclic diamines; 3,4-diaminopyridine and 1,4-diamino-2-butanone; etc. These can be used singly or in combination of two or more. In the present invention, DPE, TPE-R, etc. are especially preferable.

Other amine compounds, such as monoamine compounds, polyamine compounds, etc., can be used as well as diamine compounds. Use of such an amine compound can modify the properties of the resulting polyamic acid or polyimide.

The solvent used in the second solution is not limited as long as it substantially dissolves the diamine compound and does not dissolve the polyamic acid formed. Examples of usable solvents include 2-propanone, 3-pentanone, tetrahydropyrene, epichlorohydrin, acetone, methyl ethyl ketone (MEK), tetrahydrofuran (THF), ethyl acetate, acetanilide, methanol, ethanol, isopropanol, etc. At least one of these solvents can be used as the solvent for the second solution. Solvents that dissolve polyamic acids, for example, aprotic polar solvents such as DMF, DMAc, NMP, etc., are also usable when they are mixed with poor solvents for polyamic acids, such as acetone, ethyl acetate, MEK, toluene, xylene, etc., and thereby adjusted so as to precipitate polyamic acids.

The diamine compound concentration of the second solution can be suitably selected depending on the type of diamine compound used, the concentration of the first solution, etc., and is usually about 0.001 to about 0.20 mol/l, and preferably about 0.01 to 0.10 mol/l.

Subsequently, in the second step, the first solution and the second solution are mixed together to precipitate fine polyamic acid particles from the mixed solution. The mixing ratio of the first solution and the second solution can be suitably selected according to the types of tetracarboxylic anhydride and diamine compound, the concentration of each solution, etc., and is usually such that the tetracarboxylic anhydride:diamine compound molar ratio is about 1:0.5 to about 1:1.5, and preferably about 1:0.9 to about 1:1.1.

In the second step, it is particularly preferable to precipitate the polyamic acid while stirring. Stirring can be performed using a known stirring method (stirring device). In the present invention, ultrasonic stirring is especially preferable. Ultrasonic stirring makes it possible to obtain fine particles having a mean diameter that is approximately 50% smaller than that of particles obtained by an ordinary stirring method. Ultrasonic stirring can be performed using a known ultrasonic device (e.g., ultrasonic washer) under known operation conditions. The frequency of the ultrasonic waves can be suitably selected according to the desired particle diameter and the like, and is usually about 28 to about 100 kHz, and preferably about 28 to about 45 kHz.

The temperature in the second step is not limited, and is usually about 0 to about 130° C., and preferably about 20 to about 40° C. Stirring may be carried out until the polyamic acid is substantially completely precipitated. The stirring time is usually about 30 seconds to about 30 minutes, but may be out of this range.

The fine polyamic acid particles formed by precipitation in the second step can be recovered by solid-liquid separation using a known method, such as centrifugation or the like. When the fine polyamic acid particles (powder) formed in the second step are spherical, the particles are generally monodisperse particles having a mean particle diameter of about 0.03 to about 0.7 μm, and preferably about 0.03 to about 0.55 μm, a standard deviation of about 0.02 to about 0.07, and preferably about 0.02 to about 0.055, and a coefficient of variation of 3 to 15%, and preferably 3 to 9%. When the particles have irregular shapes, each particle usually has a mean size of about 0.5 to about 1.0 μm.

### Metal Ion Adsorption Step

In the production method of the present invention, metal ions are first adsorbed to the above-described fine polyamic acid particles. The method for adsorbing metal ions is not limited as long as the fine polyamic acid particles and metal ions can be brought into sufficient contact with each other in an aqueous solution.

Usually, the fine polyamic acid particles are added to an aqueous solution containing metal ions to thereby bind, by a cation exchange reaction, the metal ions to carboxy groups contained in the fine polyamic acid particles.

The type of metal to be adsorbed is not limited, but Au, Pt, Pd, Ag, Cu, Sn, Ni, Co, etc. are preferable, and Au, Pt, Ag, Pd, Cu, etc. are more preferable, since they have an appropriate melting point for use as a conductive adhesive, and have good conductivity. These metals can be used singly or in combination of two or more.

An aqueous solution containing ions of such a metal can be prepared by dissolving a water-soluble compound of the metal in water. Examples of usable gold compounds include gold acetate, gold sulfite, gold thiosulfate, chloroauric acid, etc. Examples of usable silver compounds include silver acetate, silver nitrate, silver sulfate, etc. Examples of usable copper compounds include copper acetate, copper sulfate, copper chloride, copper nitrate, etc. Examples of usable palladium compounds include palladium chloride, palladium sulfate, etc.

The metal ion concentration of the aqueous solution is not limited, but in order to enable efficient adsorption, for example, the metal ion concentration is preferably about 0.001 to about 1 mol/l, and more preferably about 0.01 to about 0.5 mol/l.

The amount of the fine polyamic acid particles to be added is also not limited. In accordance with the amount of the fine polyamic acid particles added, the equilibrium amount of metal ions in the aqueous solution are bound to carboxy groups. However, when a large amount of polyamic acid particles is added, the liberated H⁺ ions lower the pH and the adsorbed metal component is dissolved again. Thus, when a large amount of fine polyamic acid particles is added, it is preferable to adjust the pH to about 3 to about 4 by, for example, adding a dilute aqueous solution of sodium hydroxide or the like. In order to increase the amount of adsorbed metal ions, it is preferable to continuously add a metal ion-containing aqueous solution and separate the effluent, to thereby suppress the change in pH.

By such a method, the amount of adsorbed metal ions at the maximum corresponds to the ion exchange capacity of carboxy groups, and the amount of adsorbed metal ions per unit volume is about 27 mmol/cm³ at the maximum in the case of divalent metal ions, and about 54 mmol/cm³ at the maximum in the case of monovalent ions.

The temperature of the metal ion-containing aqueous solution is not limited, and the aqueous solution can usually be used at room temperature without being heated. The treating time is usually from about 1 to about 5 minutes.

### Reduction Step

After adsorbing metal ions to fine polyamic acid particles by the above method, a reduction treatment is performed to reduce the metal ions and disperse the metal component as ultrafine particles in the polyamic acid resin.

The reduction method is not limited. Usable methods include, for example, (i) contact with an aqueous solution containing a reducing agent, (ii) heating in a hydrogen stream, (iii) ultraviolet irradiation, etc.

### (i) Reduction Using Aqueous Solution of Reducing Agent:

Usable methods for contact with an aqueous solution containing a reducing agent include a method in which the fine polyamic acid particles to which metal ions have been adsorbed is added to an aqueous solution containing a reducing agent; a method in which an aqueous solution containing a reducing agent is gradually added to the fine polyamic acid particles to which metal ions have been adsorbed; etc.

The type of reducing agent is not limited, and various reducing agents can be used, including, for example, dimethylamine borane, sodium borohydride, phosphinate, formaldehyde, ascorbic acid, formic acid, etc. Among these, dimethylamine borane is preferable since it has a relatively moderate reducing power and can readily form ultrafine metal particles in the resin. Formaldehyde is particularly effective for reducing ions of Au, Pt, Ag, Pd, and Cu; and ascorbic acid and formic acid are particularly effective for reducing ions of Au, Pt, Ag, and Pd.

The reducing agent concentration is preferably about 0.0001 to about 1 mol/l, and more preferably about 0.01 to about 0.5 mol/l.

The amount of the fine polyamic acid particles is not limited, and is preferably up to the amount that decreases the amount of the reducing agent to about one-fifth. When the reducing agent concentration is lowered, the reduction reaction can be allowed to proceed by gradually adding an aqueous solution containing a reducing agent.

The temperature of the aqueous solution containing a reducing agent is preferably about 10 to about 80° C., and more preferably about 20 to about 50° C. The treating time is usually about 1 to about 10 minutes at room temperature, and can be shortened when the temperature of the treating solution is high.

### (ii) Heat Treatment in Hydrogen Stream:

Pure hydrogen gas or a hydrogen-containing mixed gas with a hydrogen gas: inert gas (nitrogen gas or the like) ratio of up to about 1:10. The flow rate of the hydrogen gas or hydrogen-containing mixed gas is not limited, and is usually about 1 cm³/min to about 1000 cm³/min.

The heat treatment temperature needs to be lower than about 250° C., which is a temperature at which the polyamic acid is thermally dehydrated and converted to a polyimide. It is usually preferable that the heat treatment temperature be about 20 to about 230° C. The heat treatment time varies depending on the heat treatment temperature. For example, when the heat treatment temperature is about 100° C. or higher, the heat treatment time may be about 5 to about 60 minutes, whereas when the heat treatment temperature is about room temperature, the heat treatment time is preferably about 30 minutes to about 5 hours.

(iii) Ultraviolet Irradiation:

Light equipment that can emit ultraviolet rays having a wavelength of about 170 nm to about 400 nm can, for example, be used as an ultraviolet source. Specifically, known black lights, ultraviolet lamps, LED elements, etc. can be used. The irradiation time varies depending on the metal ion adsorption amount, the wavelength of ultraviolet rays used, the irradiation distance, etc., and thus cannot be generally defined, but is usually about 1 to about 120 minutes. When using ultraviolet rays having a short wavelength, the time required for reduction can be shortened within such an irradiation time range.

The reduction by ultraviolet irradiation is effective especially when the metal component is Au, Pt, Ag, Pd, or the like.

### (2) Polyamic Acid Containing Ultrafine Metal Particles:

The methods described above can produce polyamic acids containing ultrafine metal particles, in which the metal component in the form of ultrafine particles is uniformly dispersed in fine polyamic acid particles. The state of dispersion of metal nanoparticles in the resin tends to be that the metal particles are formed more densely in portions closer to the resin surface. This is presumably because the reduction reaction proceeds from the resin surface.

The particle diameter of the ultrafine metal particles formed varies depending on the reduction method, reduction conditions, etc., but the metal particles are usually nano-sized ultrafine particles with a diameter of about 1 nm to about 10 nm. Such ultrafine particles may be continuously linked to form a sheet-like shape. As used herein, the particle diameter of the ultrafine metal particles is a mean particle diameter determined by measurement using a transmission electron microscope.

In the method of the present invention, the density of the ultrafine metal particles in the resin is linearly increased by repeating the steps of adsorption and reduction of metal ions. With such an increase, the particle diameter tends to be slightly increased. For example, when one cycle of the steps of adsorption and reduction is carried out, the particle diameter of the ultrafine metal particles is about 1 to about 2 nm and the ultrafine metal particle content is about 10 wt. %, whereas when three cycles of the steps of adsorption and reduction are carried out, the ultrafine metal particle content may be about 30 wt. % and the particle diameter may be increased to 3 to 6 nm.

In the above adsorption step, the metal ion adsorption amount per unit volume is about 27 mmol/cm³ at the maximum in the case of divalent metal ions, and is about 54 mmol/cm³ at the maximum in the case of monovalent metal ions. When such metal ions are reduced to form ultrafine particles, the content of the ultrafine metal particles in the polyamic acid containing ultrafine metal particles is about 20 wt. % at the maximum in the case of divalent ions, and is about 40 wt. % at the maximum in the case of monovalent ions.

When the adsorbed metal ions are reduced to metal, the carboxy groups are liberated and become capable of binding to metal ions again. Thus, by repeating the above-described steps of adsorption and reduction of metal ions, the content of the ultrafine metal particles can be increased to, for example, about 40 wt. % or more.

In particular, when the ultrafine metal particle-containing polyamic acid of the present invention is used as a conductive adhesive, the content of the ultrafine metal particles is preferably about 5 to about 50 wt. %.

### (3) Conductive Adhesive

The ultrafine metal particle-containing polyamic acid of the present invention comprises nano-sized ultrafine metal particles dispersed in fine polyamic acid particles. Since the metal component is present as nanoparticles, the metal component has a remarkably lowered melting point. For example, Au, Ag, etc. having a particle diameter of about 2 to about 3 nm is melted by heating at about 200° C. for about 30 seconds. Thereafter, when the melted metal is used for the joining, it becomes a bulk metal and has the melting point inherent to the metal. The polyamic acid flows out of the joint portion by the pressure for joining at about 200° C., and then, by heating at 250° C. to 300° C. for about 30 seconds, the polyamic acid is converted to a polyimide, which has chemical resistance, heat resistance, a low dielectric constant, and a high insulation resistance, thereby protecting the joint portion. Such properties enable joining at relatively low temperatures. Further, the joint portion is protected by the polyimide film, therefore maintains stable joining under high temperature conditions and is excellent in joining strength, joining reliability, etc.

When the ultrafine metal particle-containing polyamic acid of the present invention is used as a conductive adhesive, a thickener such as water-soluble polyethylene glycol, glycerol, turpentine oil, or the like is added to form a paste with a suitable viscosity, which is then applied to the joint portion. The viscosity of the paste varies depending on the application method and the like, and cannot be generally defined. The viscosity can be suitably selected according to the application method. The amount of the thickener to be used can be suitably selected according to the type of thickener and the like, so as to achieve a viscosity suitable for application. For example, the amount of the thickener can be selected from a range as wide as from about 1 to about 95 wt. %, based on the total amount of the ultrafine metal particle-containing polyamic acid and the thickener.

If necessary, fine particle fillers of Ag, Cu, Au, Pd, etc., which have been heretofore used in conductive adhesives, can be used in combination with the ultrafine metal particle-containing polyamic acid of the present invention. Such combined use further improves the conductivity of the joint portion. The amount of such a fine particle filler to be added may be such that the weight ratio of the fine particle filler to the ultrafine metal particle-containing polyamic acid of the present invention is about 1:9 to about 9:1.

The method of using the conductive adhesive of the present invention may be the same as the method of using a conventional conductive adhesive. The conductive adhesive may be applied to a joint portion by, for example, screen-printing the conductive adhesive to a joint portion on a printed circuit board; immersing a joint portion of an electronic part in the paste; or like method. The application amount varies depending on the paste concentration, intended use, etc., and can be selected so as to ensure sufficient electrical connection and joining strength. The application amount is usually about 1 μm to about 200 μm.

The heating temperature is equal to or higher than the melting point, which depends on the type, particle diameter, etc. of the ultrafine metal particles, and is within a temperature range in which the polyamic acid is converted to a polyimide, or a higher temperature. The heating is usually performed at about 100 to about 400° C. for about 0.1 to about 2 minutes.

### Effects of the Invention

In the ultrafine metal particle-containing polyamic acid of the present invention, the metal component is uniformly dispersed as nano-sized ultrafine particles in fine polyamic acid particles. Thus, the particle surface is formed from a large amount of metal atoms, and lattice vibrations are active, thereby exhibiting excellent properties characteristic of metal nanoparticles. In particular, the remarkable lowering of the melting point enables joining at relatively low temperatures. Further, a film of a polyimide formed from the polyamic acid protects the joint portion and enables highly reliable joining. Therefore, the joining method using the conductive adhesive of the present invention is highly useful as an alternative technology to joining methods using conventional high-temperature lead solders.

### BEST MODE FOR CARRYING OUT THE INVENTION

The following Examples are intended to illustrate the present invention in further detail.

### Example 1

### Production of Silver Nanoparticle-Containing Polyamic Acid

A pyromellitic dianhydride (1,2,4,5-benzenetetracarboxylic anhydride) (0.1 mol) and 4,4′-diaminophenyl ether (ODA) (0.1 mol) were separately dissolved in 100 ml-portions of acetone as a reaction solvent. The temperature of the solutions was adjusted to 25° C., the two solutions were mixed together under ultrasonic irradiation, and ultrasonic irradiation (frequency: 45 kHz) was continued for 10 minutes to obtain fine polyamic acid particles. The obtained fine polyamic acid particles were separated by centrifugation and washed with water.

One gram of the fine polyamic acid particles thus prepared was dispersed in 100 ml of water, 50 ml of 0.1 mol/l aqueous silver nitrate solution was added thereto, and the resulting mixture was gently stirred for 15 minutes to adsorb silver ions by an ion exchange reaction, followed by thorough washing with water.

The fine polyamic acid particles to which silver ions had been adsorbed were re-dispersed in 10 ml of water to obtain a dispersion. While applying vibrations, the dispersion was irradiated with ultraviolet rays having a dominant wavelength of 325 nm at room temperature for 15 minutes with a sample-to-lamp distance of 5 cm, so that the ultraviolet intensity at the sample surface became 260 mW/cm², to reduce the silver ions and thereby produce a silver nanoparticle-containing fine polyamic acid particles.

The silver nanoparticles in the obtained resin had a particle diameter of 1 to 2 nm, and the silver nanoparticle content was about 10 wt. % based on the total amount of the resin including silver nanoparticles. Electron diffraction confirmed that the nanoparticles in the resin were metallic silver.

### Performance Test of Conductive Adhesive

The silver nanoparticle-containing fine polyamic acid particles obtained by the above method was mixed with polyethylene glycol (molecular weight: 300) to prepare a paste containing 30 wt. % of the silver nanoparticle-containing fine polyamic acid particles.

Using this paste as a conductive adhesive, the paste was screen-printed to a thickness of 100 μm on a printed circuit board at a portion to be mounted with an IC lead frame.

After mounting an IC lead frame, the printed circuit board was conveyed through a primary heating furnace (210° C.) for 30 seconds, and then through a secondary heating furnace (270° C.) for 30 seconds, to join the lead frame.

When using a Sn—Pb-based solder, the joining strength at the lead joint portion is 8 kgf, whereas when using the conductive adhesive containing the silver nanoparticle-containing polyamic acid particles, the joining strength was 10 kgf, and the reliability determined using 20 leads was 10±0.3 kgf, demonstrating excellent joining strength and joining reliability. After 1000 cycles of a thermal shock test (−40° C. to +85° C., 30 minutes for each cycle), no change was observed at all in the joining strength.

The electrical resistivity between the lead and the connecting terminal of the printed circuit board was 1.8 μΩcm (20° C.), which is close to that of bulk copper, i.e., 1.724 μΩcm (20° C.), and was not changed after 1000 cycles of a thermal shock test.

### Example 2

The procedure in Example 1 was followed except for using 0.1 mol of 4,4′-oxydiphthalic anhydride (ODPA) in place of 0.1 mol of pyromellitic dianhydride, to thereby prepare fine polyamic acid particles.

Transmission electron microscope observation revealed that the obtained polyamic acid was relatively monodisperse fine particles having a mean particle diameter of 340±30 nm and a smooth surface. The infrared absorption spectrum of the fine polyamic acid particles was measured using a Fourier transform infrared spectrophotometer (FT-IR spectrophotometer). As a result, peaks attributed to a carboxy group (1700 cm⁻¹, 1440 cm⁻¹), an amide bond (1640 cm⁻¹), and an ether bond (1240 cm⁻¹) were observed. These results show that the polyamic acid was an ODPA-ODA-type polyamic acid. This polyamic acid serves as a precursor of a thermoplastic polyimide resin.

Subsequently, following the procedure in Example 1, silver ions were adsorbed to the fine polyamic acid particles by an ion exchange reaction.

The fine polyamic acid particles to which silver ions had been adsorbed were then maintained at 25° C. in a hydrogen stream for 1 hour to reduce the silver ions and thereby produce the silver nanoparticle-containing fine polyamic acid particles.

Observation of a transmission electron microscopic image of the obtained silver nanoparticle-containing fine polyamic acid particles confirmed formation of silver nanoparticles having a diameter of about 3 to about 4 nm in the fine polyamic acid particles. It was observed that the particle diameter of the silver nanoparticles tended to increase as the reduction time was increased.

The cycle of the adsorption treatment and reduction treatment of silver ions described above was carried out four times. The diameter and content of the silver nanoparticles in the resin were increased by repeating the adsorption and reduction treatments of silver ions, and after four cycles of the adsorption and reduction treatments, the diameter of the silver nanoparticles was about 5 to about 6 nm, and the silver nanoparticle content was about 15 wt. % based on the total amount of the resin including the silver nanoparticles.

### Performance Test of Conductive Adhesive

The silver nanoparticle-containing fine polyamic acid particles after being subjected to the four cycles of adsorption and reduction treatments by the above method was mixed with polyethylene glycol (molecular weight: 300) to prepare a paste containing 30 wt. % of the silver nanoparticle-containing fine polyamic acid particles.

Copper plates were used as materials to be joined. The above-obtained paste was applied to a thickness of 100 μm to a 5×10 mm area of an edge portion of a copper plate. Another copper plate was placed on the area, and heat treatment was carried out in a hydrogen stream at 330° C. for 10 minutes to join the two copper plates.

After the heat treatment, the joining strength between the joined copper plates was measured and found to be as high as about 1.03×10⁸ Nm⁻².

The electrical resistance between the joined copper plates was measured and found to be substantially 0Ω, demonstrating that the joint portion had very good conductivity.

1. A polyamic acid containing ultrafine metal particles, the polyamic acid comprising ultrafine metal particles dispersed in fine polyamic acid particles.

2. The polyamic acid containing ultrafine metal particles according to claim 1, wherein the ultrafine metal particles are those of at least one member selected from the group consisting of Au, Pt, Pd, Ag, Cu, Sn, Ni, and Co.

3. A method for producing a polyamic acid containing ultrafine metal particles, the method comprising contacting an aqueous solution containing a water-soluble metal compound with fine polyamic acid particles to adsorb metal ions to the fine polyamic acid particles; and then performing a reduction treatment.

4. The method according to claim 3, wherein the water-soluble metal compound is a compound containing at least one metal component selected from the group consisting of Au, Pt, Pd, Ag, Cu, Sn, Ni, and Co.

5. The method according to claim 4, wherein the reduction treatment is performed by (i) contact with an aqueous solution containing a reducing agent, (ii) heating in a hydrogen stream, or (iii) ultraviolet irradiation.

6. A conductive adhesive comprising as an active ingredient a polyamic acid containing ultrafine metal particles according to claim 2.

7. The method according to claim 3, wherein the reduction treatment is performed by (i) contact with an aqueous solution containing a reducing agent, (ii) heating in a hydrogen stream, or (iii) ultraviolet irradiation.

8. A conductive adhesive comprising as an active ingredient a polyamic acid containing ultrafine metal particles according to claim 1.
